(19) United States
(12) Patent Application Publication
(10) Pub. No.: US 2008/0140535 A1
(43) Pub. Date: Jun. 12, 2008

(54) SELECTION OF BEVERAGE MIXTURES

(76) Inventor: Eileen D. Turgeon, Fort Collins, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/831,390

(22) Filed: Jul. 31, 2007

Related U.S. Application Data
(60) Provisional application No. 60/873,868, filed on Dec. 7, 2006.

(51) Int. Cl. G06Q 50/00

(52) U.S. Cl. 705/15

(57) ABSTRACT

Methods are disclosed of providing a beverage serving to a customer. An indication of a color selected by the customer from a chart is received. The beverage serving is produced with a base beverage and at least one additive in a proportion that causes the beverage serving to have a color approximating the selected color. The produced beverage serving is delivered to the customer.

### CROSS REFERENCE TO RELATED APPLICATION

This application is a nonprovisional of, and claims the benefit of the filing date of, U.S. Prov. Pat. Appl. No. 60/873,868, entitled “SELECTION OF COFFEE MIXTURES,” by Eileen D. Turgeon, the entire disclosure of which is incorporated herein by reference for all purposes.

### BACKGROUND OF THE INVENTION

This application relates generally to the production of beverages. More specifically, this application relates to providing a mechanism for customers purchasing beverages to select a mixture proportion for the beverage.

In some embodiments, the invention relates specifically to the production of coffee beverages. In recent years, there has been a significant upsurge in the sales of prepared coffee to customers, with customers now able to purchase prepared coffee in a variety of different venues. Some of these venues include walk-in corner shops, drive-through coffee shops, and coffee shops disposed with buildings that accommodate other businesses. In preparing coffee for customers, one difficulty that is encountered is providing the coffee with the specific amount of creamer and sugar that the customer desires. Customers have very different tastes and can be quite particular in wishing their coffee to be prepared with the correct proportions of these additives.

Similar issues may arise in the sales of other types of beverages that where different customers have varying preferences for the addition of additives.

There is accordingly a general need in the art for an efficient mechanism to allow selections of beverage mixture proportions.

### BRIEF SUMMARY OF THE INVENTION

Embodiments of the invention provide methods providing a beverage serving to a customer. An indication of a color selected by the customer from a chart is received. The beverage serving is produced comprising a base beverage and at least one additive in a proportion that causes the beverage serving to have a color approximating the selected color. The produced beverage serving is delivered to the customer.

In some instances, the chart comprises a plurality of colors ordered from a lighter hue to a darker hue. The chart may include a plurality of identifiers, with each identifier being associated with one of the plurality of colors. The indication of the color selected by the customer comprises receiving one of the plurality of identifiers.

In certain embodiments, the indication of the color selected by the customer is received at a device. The color selected by the customer may then be communicated from the device to a clerk. Alternatively, the beverage serving may be prepared in the proportion that causes the beverage serving to have a color approximating the selected color with the device.

In a specific embodiment, the base beverage comprises coffee and the additive comprises a creamer.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a flow diagram summarizing methods of the invention in different embodiments;

FIG. 2 is an example of a selection card that may be used in implementing embodiments of the invention; and

FIGS. 3A and 3B are schematic illustrations of systems that may be used to implement methods of the invention in different embodiments.

### DETAILED DESCRIPTION OF THE INVENTION

Embodiments of the invention make use of a selection card that may be provided to customers in selecting a desired beverage mixture. The selection card makes use of the fact that certain combinations of base beverages and additives result in color changes of the mixture that may be correlated with the mixture concentrations. In the foregoing description, specific reference is sometimes made to coffee servings in which the beverage mixture comprises a mixture of coffee and creamer. Such references are intended to be illustrative rather than limiting, with mixtures of coffee and creamer providing an example of beverage mixtures that experience color changes correlated with the mixture concentrations. In such examples, indicating the desired color of a coffee serving acts as a surrogate for indicating the desired proportion of creamer to be included in the coffee serving. As used herein, the term “creamer” is used broadly. It refers to any dairy additive conventionally added to coffee servings, including synthetic dairy additives. The term thus encompasses such additives as cream, milk, microencapsulated plant-oil powders, and other similar additives.

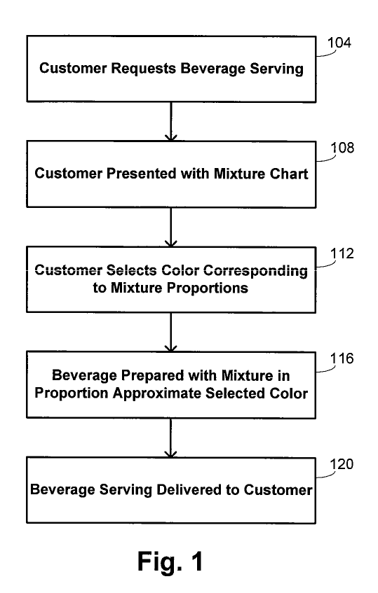

A general overview of methods of the invention for certain embodiments is provided with the flow diagram of FIG. 1. The flow diagram includes certain specific steps that may be performed and includes an exemplary order for performing them, but this is not intended to be limiting. In other embodiments, additional steps that are not explicitly indicated may be performed or other steps may be omitted. In addition, steps may sometimes be performed in a order that differs from the specific order identified in the drawing.

At block 104, a customer requests a beverage serving. Such a request may take a variety of different forms, including being communicated directly to a human being or being communicated instead to a device. For example, requests communicated to human beings may take place at such venues as a walk-in or drive-through coffee shop. Requests communicated to a device may include such requests as those made to automated beverage dispensing machines or to devices that act as interfaces to human beings at beverage-production locations. To indicate the desired beverage mixture, the customer is presented with a mixture chart at block 108. Such a chart may take the form of a portable chart that may be handed to the customer or may be provided as a panel displayed on a nonportable device.

The chart typically has a plurality of color selections that correspond to an approximate color of the beverage mixture when it includes a beverage base and additives in the desired proportions. In addition, each of the color selections will usually have an identifier associated with it so that the customer may identify the selected identifier to indicate the desired beverage mixture.

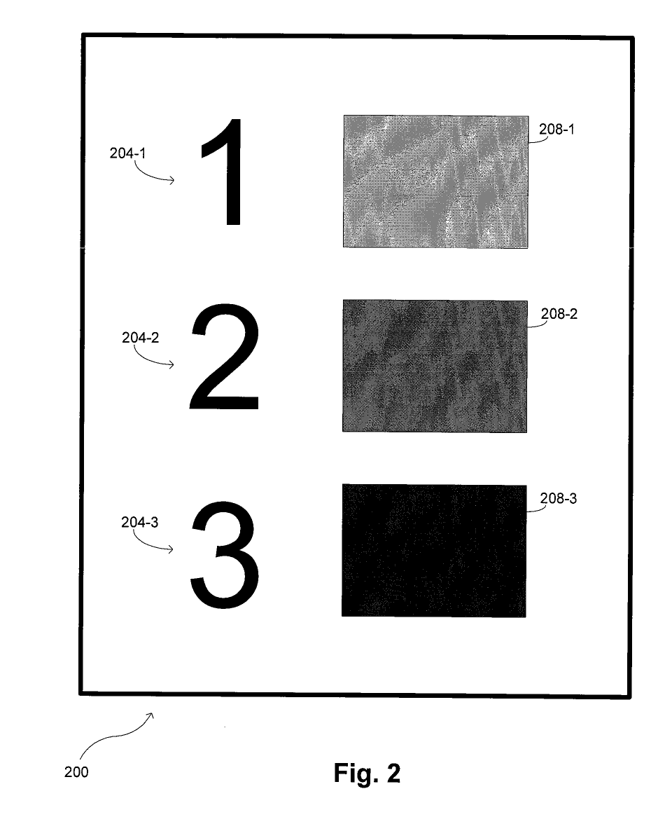

This is illustrated, for example, in FIG. 2 with a mixture chart suitable for making selections of coffee beverages with a certain amount of creamer added. The different colors are shades of brown that vary from a coffee beverage that has no creamer additive to a coffee beverage having a large amount of creamer additive. In this particular embodiment, the mixture chart 200 has three color selections 208, although a different number of color selections may be used in other embodiments. Each of the color selections has a corresponding identifier 204 in the form of arabic numerals, although other identifiers may be used in other embodiments, including the use of roman letters, pictograms, or any other suitable identifiers.

The customer makes a selection of the desired color from the chart at block 112, usually communicating his selection in the same manner as the beverage serving was requested at block 104. For example, if the beverage request was communicated directly to a human being, the identification of the desired color for the beverage mixture will usually also be communicated directly to a human being. And if the beverage request was communicated through a machine interface, the identification of the desired color may be similarly communicated.

The beverage is prepared at block 116 with additives provided in a proportion that will approximate the selected color of the beverage. Preparation of the beverage may also be performed by human beings directly or may be prepared using a device depending on the specific nature of the beverage and different embodiments being implemented. After being prepared, the beverage serving is delivered to the customer at block 120.

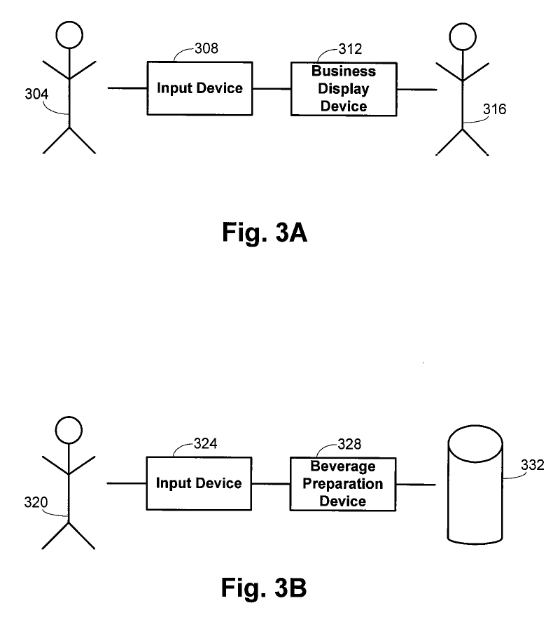

FIGS. 3A and 3B provide examples of structures shown in a schematic manner of how devices may be used in embodiments of the invention. These specific illustrations are merely provided for exemplary purposes and other configurations may be used in other embodiments. Furthermore, as previously noted, some embodiments may not use a device of any kind, with all interactions taking place between human beings.

FIG. 3A illustrates an embodiment in which a device is used to communicate between a customer 304 and a clerk 316. Such a device might be used at a walk-in or drive-up beverage shop where the customer 304 is able to enter ordering and color-selection information through an interface with the device. In its simplest form, such a device may comprise an input device 308 with which the customer 304 interacts and a business display device 312 that displays the customer requests to the clerk 316. In such a configuration, the input device 308 and the business display device 312 are connected with some kind of communications link. The clerk 316 uses the information obtained from the customer 304 in this way to prepare the beverage to approximate the desired color as described above.

FIG. 3B illustrates an embodiment in which a device is used to prepare the beverage 332 itself. In this arrangement, a customer 320 interacts with an input device 324 in a manner similar to that of FIG. 3A, but information obtained by the input device 324 is used by a beverage preparation device 328 to prepare the beverage 332 in accordance with the specified color. In such an embodiment, the beverage preparation device 328 will usually have a preconfigured specification of relative amounts of base beverage and additive to be included and will prepare the beverage 332 in accordance with that specification.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method of providing a beverage serving to a customer, the method comprising:
receiving an indication of a color selected by the customer from a chart;
producing the beverage serving comprising a base beverage and at least one additive in a proportion that causes the beverage serving to have a color approximating the selected color; and
delivering the produced beverage serving to the customer.

2. The method recited in claim 1 wherein the chart comprises a plurality of colors ordered from a lighter hue to a darker hue.

3. The method recited in claim 2 wherein:
the chart includes a plurality of identifiers, each such identifier being associated with one of the plurality of colors; and
receiving the indication of the color selected by the customer comprises receiving one of the plurality of identifiers.

4. The method recited in claim 1 wherein receiving the indication of the color selected by the customer comprises receiving the indication at a device.

5. The method recited in claim 4 further comprising communicating the color selected by the customer from the device to a clerk.

6. The method recited in claim 4 further comprising preparing the beverage serving in the proportion that causes the beverage serving to have a color approximating the selected color with the device.

7. The method recited in claim 1 wherein:
the base beverage comprises coffee; and
the additive comprises a creamer.

8. A method of producing a coffee serving to a customer, the method comprising:
receiving an indication of a color selected by the customer from a chart;
producing the coffee serving comprising coffee and creamer in a proportion that causes the coffee serving to have a color approximating the selected color; and
delivering the produced coffee serving to the customer.

9. The method recited in claim 8 wherein the chart comprises a plurality of colors ordered from a lighter hue to a darker hue.

10. The method recited in claim 9 wherein:
the chart includes a plurality of identifiers, each such identifier being associated with one of the plurality of colors; and
receiving the indication of the color selected by the customer comprises receiving one of the plurality of identifiers.

11. The method recited in claim 8 wherein receiving the indication of the color selected by the customer comprises receiving the indication at a device.

12. The method recited in claim 11 further comprising communicating the color selected by the customer from the device to a clerk.

13. The method recited in claim 11 further comprising preparing the coffee serving in the proportion that causes the coffee serving to have a color approximating the selected color with the device.

14. A chart comprising:
a plurality of colors, each color corresponding to a color produced by a mixture of coffee and creamer in a particular proportion; and
a plurality of identifiers, each such identifier being associated with one of the plurality of colors.

15. The chart recited in claim 14 wherein the plurality of colors are ordered from a lighter hue to a darker hue.

16. A system for producing a beverage serving to a customer, the system comprising:
an input device having instructions to receive an indication of a color selected by the customer from a chart; and
a production device having instructions to produce the beverage serving comprising a base beverage and at least one additive in a proportion that causes the beverage serving to have a color approximating the selected color.

17. The system recited in claim 16 wherein the chart comprises a plurality of colors ordered from a lighter hue to a darker hue.

18. The system recited in claim 17 wherein;
the chart includes a plurality of identifiers, each such identifier being associated with one of the plurality of colors; and
the instructions to receive the indication of the color selected by the customer comprise instructions to receive one of the plurality of identifiers.

19. The system recited in claim 16 wherein:
the base beverage comprises coffee; and
the additive comprises a creamer.
